(19) United States
(12) Patent Application Publication
(10) Pub. No.: US 2023/0295979 A1
(43) Pub. Date: Sep. 21, 2023

(54) PROJECT TYPE WINDOW SYSTEM

(71) Applicant: SUNFLEUR ENERGY SOLUTION CO., LTD., Suwon-si Gyenoggi-do (KR)

(72) Inventor: Chun Hwan NAM, Daegu (KR)

(21) Appl. No.: 17/918,392

(22) PCT Filed: Dec. 16, 2021
(86) PCT No.: PCT/KR2021/019155

§ 371 Date: Oct. 12, 2022

(30) Foreign Application Priority Data
Jun. 16, 2021 (KR) 10-2021-0078008
Jun. 16, 2021 (KR) 10-2021-0078017
Jun. 16, 2021 (KR) 10-2021-0078026

(51) Int. Cl. E06B 3/38; E06B 7/08; H02S 20/26

(52) U.S. Cl. CPC E06B 3/38; E06B 7/08; H02S 20/26

(57) ABSTRACT

Embodiments of the present invention relates to a window system that a solar panel provided in the project window is easily detachable, and more particularly, a project type window system according to present invention includes a window frame; a project frame with an upper end hinged to an upper end of the window frame configured to be opened and closed in a project type while moving away or close with respect to the window frame; a louver frame provided inside the project frame; and a solar panel including a solar cell and a photovoltaic frame to support the solar cell; wherein the louver frame includes a supporting plate with a tilt hole elongated in a height direction of the project frame, a panel holder for fixing and holding the solar panel inside of the supporting plate by including a tilt shaft on an opposite side to which the solar panel is held and inserting the tilt shaft into the tilt hole, and a socket for tiltably supporting the solar panel with respect to the louver frame from an outside of the supporting plate by being coupled to the tilt shaft, wherein the photovoltaic frame is slide-inserted through an opened one end of the panel holder, and is supported by the other end of the panel holder, and wherein the photovoltaic frame is coupled to the panel holder in the other end of the panel holder.

### TECHNICAL FIELD

The present invention relates to a window that opens and closes in a project type, and more particularly, relates to a window system that a solar panel provided in the project window is easily detachable.

### BACKGROUND ART

As greenhouse gas reduction becomes a major issue in countries around the world, methods to reduce greenhouse gas are emerging one after another. One of these measures is to install a solar panel in a building or install a solar panel in a part of the building in order to reduce the use of fossil energy. The solar panels may be broadly divided into BAPV (Building Applied PhotoVoltaic) system or BIPV (Building Integrated PhotoVoltaic) system.

However, there is a problem in that it has to be customized according to the installation environment because the BIPV system has to act as a construction material for a building while performing a power generation function. In addition, even if the BIPV system was installed, there is a problem in that the power generation efficiency is low due to the influence of the incident angle of sunlight, shade, and the like.

In order to solve this problem, the present inventor has invented a window for photovoltaic power generation system (KR 10-1922890) that can be affected as little as possible by the incident angle of sunlight or shade by tilting the solar panel while the window is opened and closed in a project type.

FIG. 1 shows a conventional BIPV system in a project opening and closing type, the conventional BIPV system in a project opening and closing type includes a first frame 1 installed on the exterior window frame of a building, a second frame 3 coupled to the first frame 1, and a photovoltaic module 5 which is composed of a plurality of solar panels and installed in the inner side of the second frame 3. And, the second frame 3 performs to open and close in the project type, and power generation efficiency is maximized by tilt of the solar panel in the photovoltaic module 5.

Since the conventional BIPV system in a project opening and closing type is installed in place of the window of a building, it is difficult to be separated while being once installed. However, when replacement of a solar panel is required due to damage from physical collision or circuit damage from electric shock, there is a problem that it is difficult to maintain or repair the conventional BIPV system in a project opening and closing type.

In addition, the conventional BIPV system in a project opening and closing type does not disclose a transmission structure of power generated by the solar panel. And, considering the characteristics of the project window, there is a possibility that the electric wire may be damaged by being caught in the project window due to the structure that opens and closes by tilting the solar panel, and it cannot provide a solution.

In addition, the conventional BIPV system in a project opening and closing type has a problem in that the solar panel consists only of a photovoltaic cell and a frame supporting the cell, so that when the photovoltaic panel is closed, it is difficult to block water and air.

### DETAILED DESCRIPTION OF THE INVENTION

### Technical Problem

The present invention has been invented to solve the above problems, and the subject matter to be solved by the present invention is to provide a project type window system that is easy to maintain and repair because the solar panel is easily detachable.

In addition, the subject matter to be solved by the present invention is to provide a project type window system to prevent pinching or disconnection of electric wires from the inside.

In addition, the subject matter to be solved by the present invention is to provide a project type window system having excellent performance to block water and air.

### Technical Solution

A project type window system provided according to the present invention may include

### Advantageous Effects

The project type window system according to the present invention is easy to maintain and repair because the solar panel can be separated from the indoor side.

In addition, the project type window system according to the present invention may prevent damage or disconnection of an electric wire because the electric wire is routed through a point where a position is not change, such as a hinge bar or a tilt shaft.

In addition, the project type window system according to the present invention may prevent pinching or disconnection of electric wires by placing a recess in a component that may interfere with a path through which electric wires are routed.

In addition, the project type window system according to the present invention may provide high tightness because a slit and a protrusion are fitted and sealed between the solar panels when the solar panels are closed.

### BRIEF DESCRIPTION OF DRAWINGS

FIG. 1 shows a conventional BIPV system in a project opening and closing type.

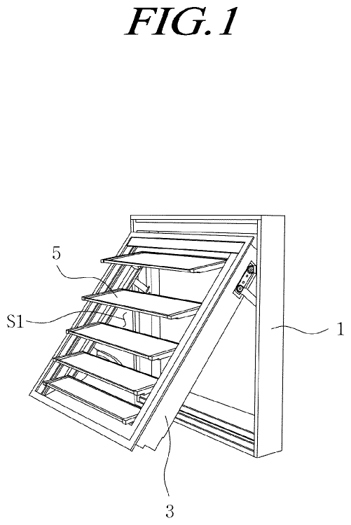

FIG. 2 is a perspective view of a project type window system according to the present invention.

FIG. 3 is a partial exploded perspective view showing a combined structure of the project frame, the louver frame and the solar panel.

FIG. 4 is a schematic diagram showing an entire form of wire in the present invention.

FIG. 5 is a view showing a coupling structure of the louver frame and the solar panel.

FIG. 6 is an operation state diagram of the louver frame and the solar panel.

FIG. 7 is a view showing a coupling structure in which a photovoltaic frame is coupled to the louver frame.

FIG. 8 is a view showing the combined form in which a photovoltaic frame is coupled to the louver frame.

FIG. 9 shows another embodiment of the louver frame.

FIG. 10 is an operation state diagram of another embodiment of the louver frame and the solar panel.

FIG. 11 is an exploded perspective view of a solar panel.

FIG. 12 is a cross-sectional view of a photovoltaic frame.

FIG. 13 is a cross-sectional view when the solar panel is closed by tilting.

FIG. 14 shows an embodiment in which a water stop rubber is inserted into the photovoltaic frame.

### MODE FOR CARRYING OUT THE INVENTION

Hereinafter, a project type solar window system with a fall protector according to the present invention will be described in detail with reference to the accompanying drawings.

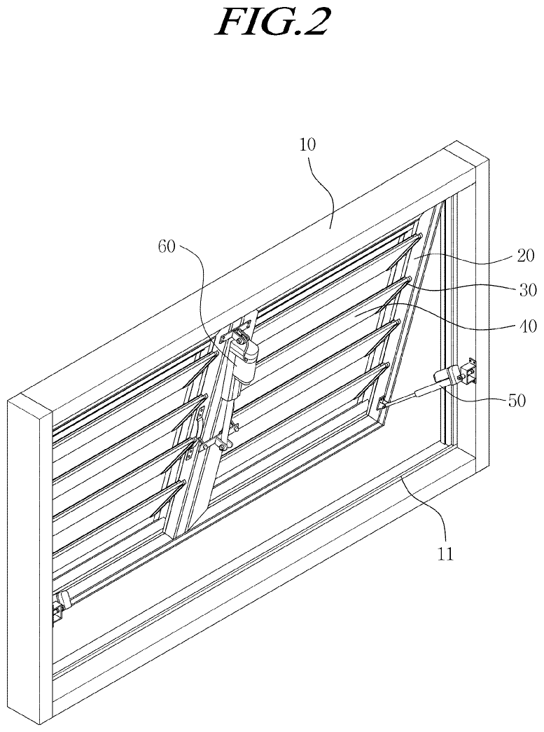

FIG. 2 is a perspective view of a project type window system according to the present invention. The project type window system according to the present invention may include a window frame 10, a project frame 20 configured to be opened and closed in a project type with respect to the window frame 10, a louver frame 30 provided on the inside of the project frame 20 and a solar panel 40 that is tilted by being coupled to the louver frame 30. Also, it may further include a project cylinder 50 for opening and closing the project frame 20 in a project type with respect to the window frame 10 and a tilt cylinder 60 for tilting the solar panel.

The window frame 10 is a component that allows the project type window system according to the present invention serves as a window by being installed in a building to form the outermost part of the project type window system according to the present invention. A threshold 11 protruding to the inside of the window frame 10 is configured to enable to block water and air from outside when the project frame 20 is closed.

The project frame 20 is a component to be opened and closed in a project type due to an upper end hinged to the upper end of the window frame 10 and a lower end configured to move away or close to the window frame 10.

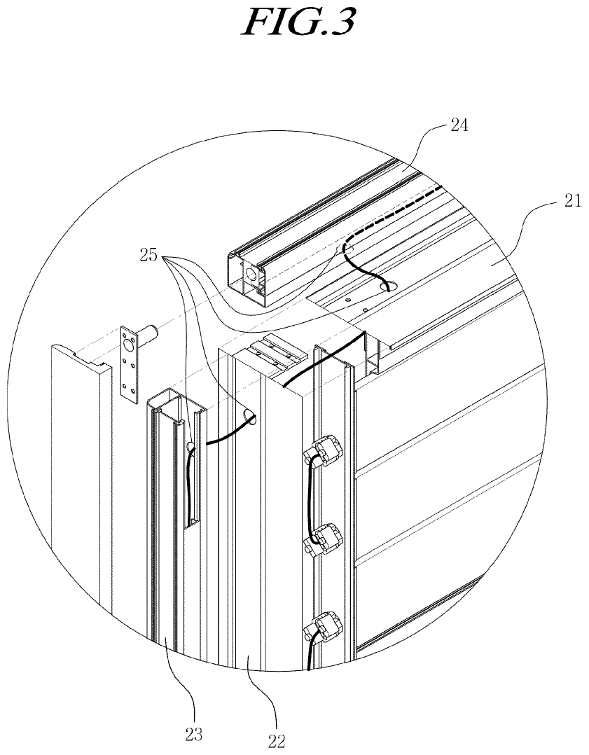

FIG. 3 is a partial exploded perspective view showing a combined structure of the project frame, the louver frame and the solar panel. The project frame 20 includes an upper cover 21, a side cover 22, a lower cover (not shown), a duct 23 coupled to the outside of the side cover 22 to become a passage for electric wires, and a hinge bar 24 coupled on the upper cover 21 to enable the project frame 20 to rotate in a project type that form a quadrangular frame to embed the louver frame 30 inside. And, wire holes 25 are formed at the upper cover 21, the side cover 22 and the hinge bar 24. Due to above structure, the project type window system according to the present invention may connect the electric wire coupled to the solar panel 40 to the external device through the duct 23, the side cover 22, the upper cover 21, and the hinge bar 24 using the wire holes 25. Also, it is possible to transfer the power generated by the solar panel 40 to the outside, for example an inverter or a power storage device, of the project type window system according to the present invention.

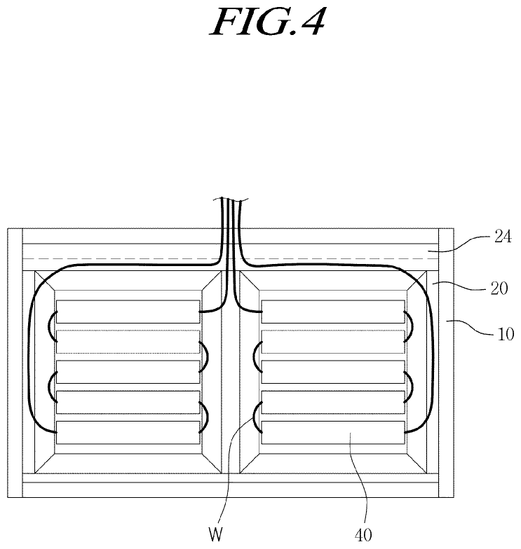

FIG. 4 is a schematic diagram showing an entire form of wire in the present invention. Considering an inverter voltage of several tens of volts V, a plurality of solar panels 30 generating a voltage of several volts V must be connected in series by an electric wire W. And both ends of the series-connected electric wire W must be connected to an external device. Due to a nature of the project frame 20 which is operated in a project type, as the distance between the project frame 20 and the window frame 10 increases, the wiring of the electric wire W becomes more difficult, and the electric wire W may be caught between the window frame 10 and the project frame 20. Therefore, in a configuration of the present invention, it would be preferable that the electric wire W is connected to the external device through the hinge bar 24, which is at a point that the project frame 20 rotates with respect to the window frame 10.

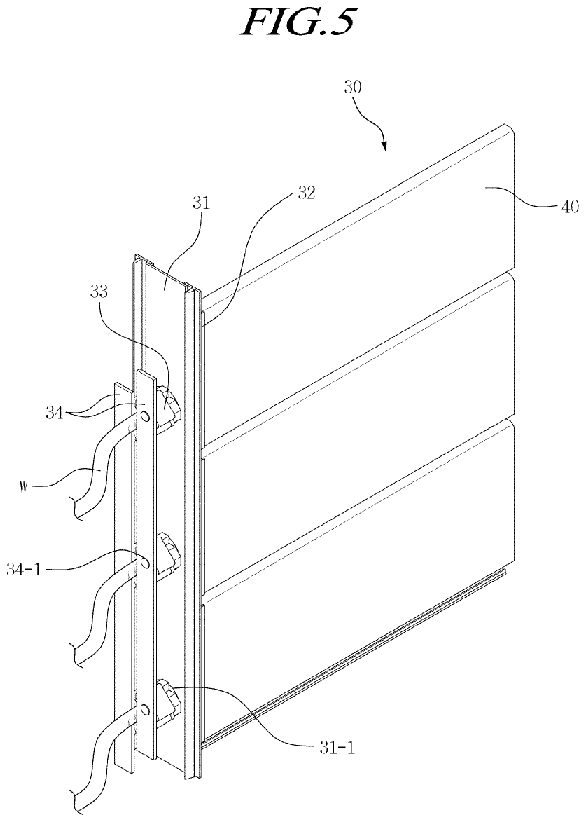

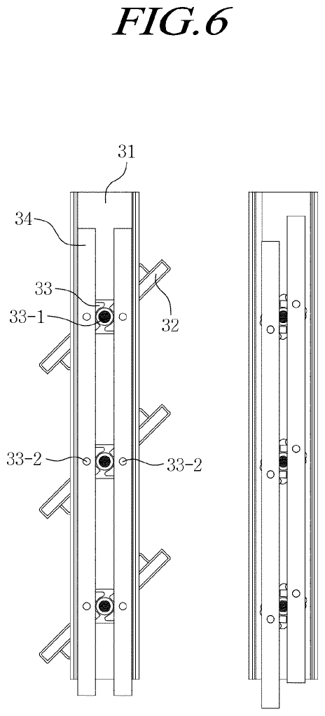

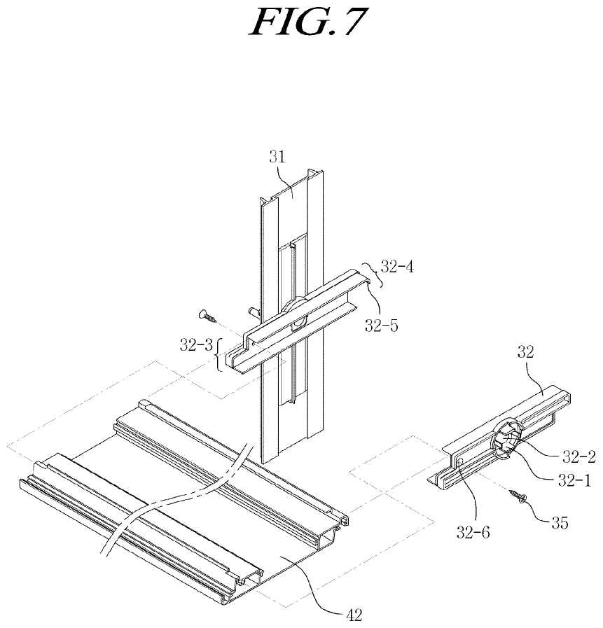

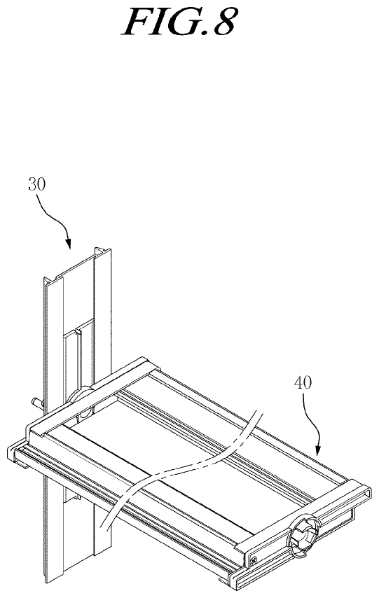

FIG. 5 is a view showing a coupling structure of the louver frame and the solar panel, FIG. 6 is an operation state diagram of the louver frame and the solar panel, FIG. 7 is a view showing a coupling structure in which a photovoltaic frame is coupled to the louver frame, and FIG. 8 is a view showing the combined form. (Since the photovoltaic frame 42 is coupled to the louver frame 30, FIGS. 7 and 8 show the photovoltaic frame instead of a solar panel. The photovoltaic frame 42 is a component of the solar panel 40). The louver frame 30 is provided inside the project frame 20 to enable to tilt the solar panel 40, and the louver frame includes a supporting plate 31, a panel holder 32, a socket 33, and a tilt strip 34.

The supporting plate 31 is a plate-shaped component elongated in the height direction of the project frame 20, and tilt holes 31-1 are formed on both sides of the solar panel 40 for each solar panel 40 at a position corresponding to the shaft on which the solar panel 40 is tilted. The reason why the tilt holes 31-1 are formed is that the rotating shaft in the solar panel 40 must come out of the supporting plate 31 to rotate the solar panel 40 in the louver frame 30.

The panel holder 32 is a component for fixing and holding the solar panel 40 inside of the supporting plate 31. A tilt shaft 32-1 is formed on the opposite side to which the solar panel 40 is held and a wire hole 32-2 is formed in the center of the tilt shaft 32-1. Considering the cross-section viewed in the direction of holding the solar panel 40, since one end 32-3 of the panel holder 32 is opened, and the other end 32-4 is formed with a locking jaw 32-5 and only partially opened, a bolt hole 32-6 is formed in the opened one end 32-3. This is to facilitate coupling and separation of the solar panel 40 and will be described later.

The socket 33 is coupled to the tilt shaft 32-1 of the panel holder 32 at a position outside of the supporting plate 31, and serves to allow the solar panel 40 to tilt with respect to the louver frame 30. In addition, since a wire hole 33-1 is formed in the center, the electric wire W formed in the solar panel 40 and the project frame 20 may be electrically connected through the socket 33. The reason why the electric wire W is connected through the socket 33 located on the rotating shaft of the solar panel 40 is the same as the case described above with reference to FIG. 4 as an example. The socket 33 includes one or more protrusions 33-2.

The tilt strips 34 are components to connect vertically the protrusion 33-2 of the socket 33 in the height direction of the project frame 20 by a hole 34-1 formed at a position corresponding to the protrusion 33-2 of the socket 33. Accordingly, the tilt strips 34 are formed as much as the number of protrusions 33-2 in the socket 33 on both sides of the solar panel 40. The socket 33 may have one protrusion 33-2 and one tilt strip 34, but if the friction force for the tilt motion is different for each solar panel 40, it is difficult to tilt the solar panel 40 smoothly. Therefore, it is preferable to provide two protrusions 33-2 and two tilt strips 34 on the socket 33 to tilt as if pair forces act. The tilt strip 34 is not fixed to the protrusion 33-2 but is provided in a state of being rotatably coupled with respect to the protrusion 33-2. Therefore, all the solar panel 40 may be tilted at once by moving the tilt strip 34 up and down.

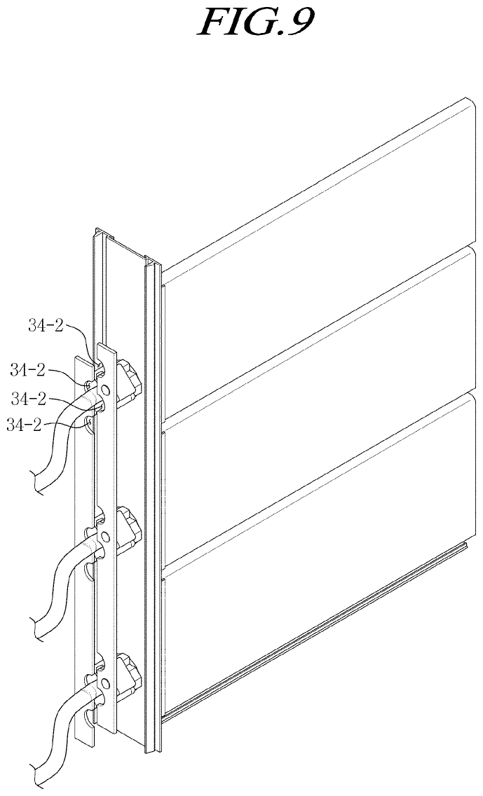

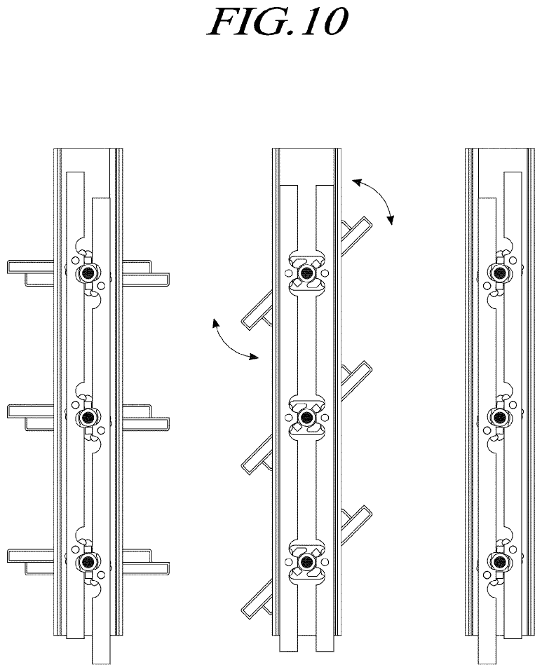

However, in case that two tilt strips 34 are formed per one side of the louver frame 30, the electric wire W may be pinched between the tilt strips 34 as shown in FIG. 6B when the solar panel 40 is completely opened or completely closed (the electric wire may be pinched when the solar panel is opened or when it is closed depending on the position of the protrusion 33-2 of the socket 33) since the electric wire W passes between the tilt strips 34. FIG. 9 shows another embodiment of the louver frame, in which two recesses 34-2 are formed on opposite surfaces of a pair of tilt strips 34, respectively. In FIG. 9, the recesses are semicircular, and as shown in FIG. 10, the recesses 34-2 of the tilt strip 34 facing with each other have a function to wrap the electric wire W like a wire hole as the solar panel 40 is tilted. Therefore, it is possible to prevent the wire pinching phenomenon occurring in the structure of FIG. 5 or 6, and thus, the risk of failure such as disconnection or electric leakage is significantly lowered.

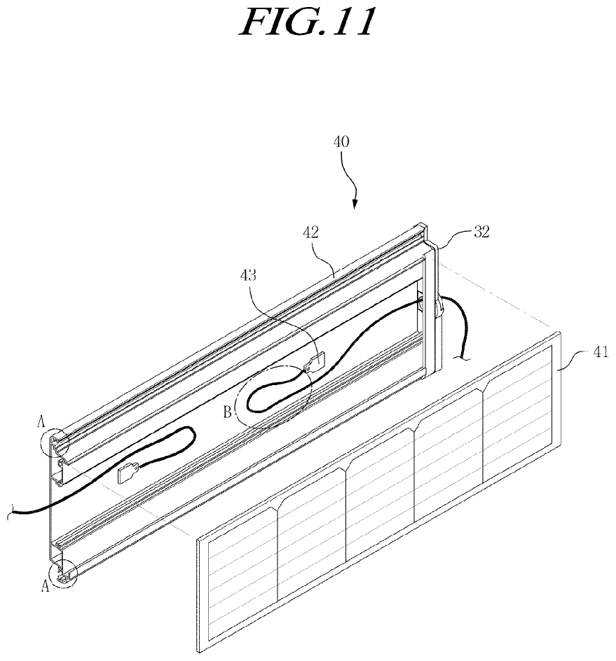

FIG. 11 is an exploded perspective view of a solar panel (a panel holder 32 is shown together for convenience of description). The solar panel 40 includes a solar cell 41 and a photovoltaic frame 42 supporting the solar cell 41. And, a connector 43 is formed to connect the solar cell 41 to an electric wire W in the photovoltaic frame 42.

Both ends A constituting the width of the photovoltaic frame 42 have a thickness thinner than the thickness of the solar panel 40, preferably ½ of the solar panel 40, so that the cross section of the end is as if a flat plate was slightly bent. This is because both ends of the adjacent solar panel overlap and a surface of the closed solar panel must be close to a plane when the solar panel 40 is completely closed by tilting.

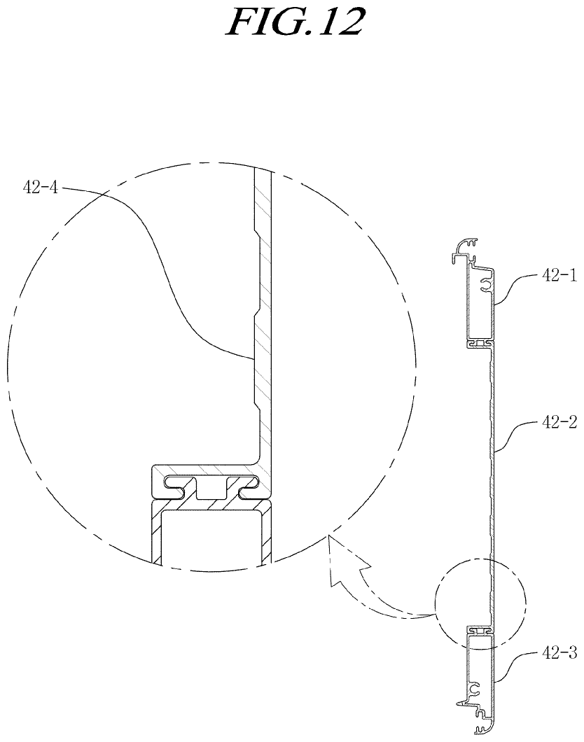

It is preferable that the photovoltaic frame 42 is divided into three or more including a plurality of first subframes 42-1, preferably corresponding to any one of both ends, a third subframe 42-3 corresponding to the other one of both ends, and a second subframe 42-2 connecting the first subframe 42-1 and the third subframe 42-3 as shown in FIG. 12. This is related to manufacturing problems, ease of change of the solar panel specifications, and ease of maintenance. First, considering the manufacturing problem, when the photovoltaic frame 42 is manufactured by press, an equipment having a high press force must be used since the press cross-sectional area of the photovoltaic frame 42 is widened if the width of the solar panel is large. In particularly, there are problems that it is difficult to obtain the equipment and that it is expensive even if it is obtained. In order to use general press equipment, it is difficult to increase the cross-sectional area of press. In this case, since there is no choice but to make the photovoltaic frame 42 thin (the thickness of the thin plate constituting the photovoltaic 42, not the entire thickness of the photovoltaic frame 42), there is a problem in that the photovoltaic frame 42 is easily crushed by an external force or has poor durability (since the thickness of the thin plate must be reduced in order to widen the press width while maintaining the press cross-sectional area). When the photovoltaic frame 42 is separated into a plurality as shown in FIG. 12, there is no need to sacrifice strength and durability of the photovoltaic frame 42 since each of the separated parts 42-1, 42-2, and 42-3 can be pressed with a general press equipment (According to this principle, the third subframe 42-2 may be further divided for ease of manufacture). The ease of change of the solar panel specification means that even if the width of the solar cell 41 is changed to 10 cm, 15 cm, 20 cm, etc., only the second subframe 42-2 which is the separated central portion can be changed. That is, when manufacturing solar cell 41 with different widths, it is easy to respond to changes in photovoltaic panel specifications since only the press mold of the second subframe 42-2 is manufactured without the need for an press mold for each width of the solar cell 41 and the press molds of the first subframe 42-1 and the third subframe 42-3 can be used as they are. It is possible to prevent deformation due to external force by forming a rib 42-4 on the second subframe 42-2 of the photovoltaic frame 42. The ease of maintenance and repair is similar to the ease of change of the photovoltaic panel specification. When the photovoltaic frame 42 is damaged, there is no need to replace entire photovoltaic frame 42 and only the damaged part among each separated parts 42-1, 42-2 and 42-3 can be replaced.

It is preferable that a terminal side of the connector 43 is disposed to face the outside in the longitudinal direction of the solar panel 40, that is, to face the panel holder 32. This is to easily separate the solar panel 40 from the inside of the building. If the terminal of the connector 43 faces the inside in the longitudinal direction of the solar panel 40, the electric wire W coupled to the connector 43 is connected to the outside through the panel holder 32 in the shortest path. Therefore, when trying to detach the solar panel 40 from the panel holder 32, the solar panel 40 can be easily moved out to indoors (in the direction of the arrow in FIG. 9) since there is no room for the length of the electric wire W. On the other hand, in the case of the configuration as shown in FIG. 11, the electric wire W is located at inside with a certain curvature in order to connect the electric wire W to the connector 43 when trying to pull out the solar panel 40 from the panel holder 32. Therefore, it is possible to maintain and repair like replacement of the solar cell 41 and the connector 43 since there is enough room to enter into the interior (about B in FIG. 11) with a certain curvature when trying to detach the solar panel from the panel holder 32.

It will be described again with reference to FIGS. 7 and 8. The photovoltaic frame 42 is slide-inserted through the open end 32-3 of the panel holder 32 and is supported by the locking jaw 32-5 of the other end 32-4 of the panel holder 32. Thereafter, the photovoltaic frame 42 is coupled to the panel holder 32 by a coupling mean at the other end 32-4 of the panel holder 32. If the coupling mean is a bolt 35, a bolt hole 32-6 is formed in the panel holder 32 and the photovoltaic frame 42 is coupled to the panel holder 32 through it. In the present invention, the reason why the locking jaw 32-5 is formed by partially opening the other end 32-4 of the panel holder 32 is related to the ease of detachment and coupling of the solar panel 40 described above. Since it is difficult to detach the project type window system according to the present invention once installed in a building, only the solar panel 40 is repaired or replaced by detaching from it in many cases. Therefore, it must be possible to easily remove the solar panel 40 at inside. If the bolts are coupled at both sides (the outdoor side and the indoor side when tilt-opened) of the panel holder 32, it is very difficult to loosen the outdoor side bolts. On the other hand, as shown in FIG. 7, if the outdoor side is supported by the locking jaw 32-5 and the indoor side is fixed with bolts 35 or the like, the solar panel 40 can be easily removed to the inside only by loosening the indoor side bolt 35.

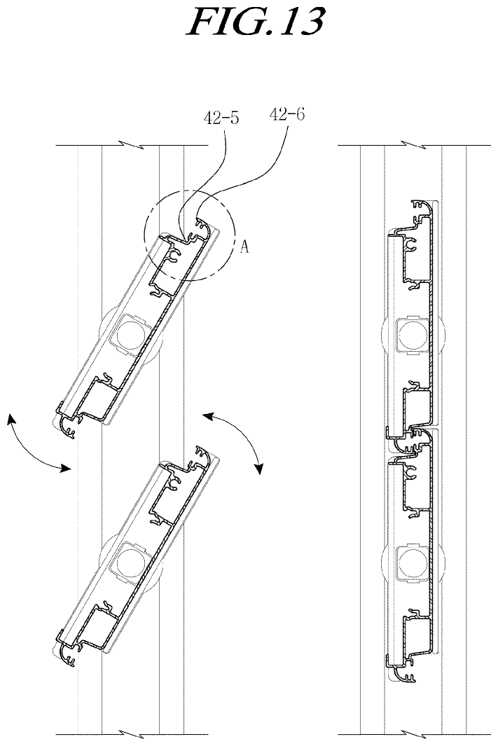

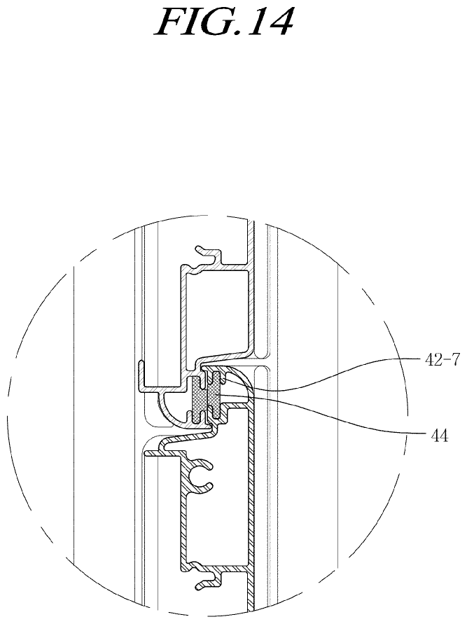

FIG. 13 is a cross-sectional view when the solar panel is closed by tilting. A slit 42-5 and protrusion 42-6 are formed at both ends constituting the width of the photovoltaic frame in order to block water and air by meeting the photovoltaic frames 42 of the adjacent solar panel 40 when fully closed. That is, it can be seen that the protrusion 42-6 is inserted into the slit 42-5 of the adjacent solar panel 40. FIG. 14 shows an embodiment in which a water stop rubber is inserted into the photovoltaic frame. A holding portion 42-7 is formed at both ends A of the photovoltaic frame 42 along the length, and a long water stop rubber 44 is inserted into the holding portion 42-7, so that the water stop rubbers 44 are compressed with each other when the adjacent photovoltaic frames 42 come into contact with each other and an excellent effect blocking from water and air can be achieved.

The project cylinder 50 is installed between the window frame 10 and the project frame 20, so that the project frame 20 can be opened and closed in project type with respect to the window frame 10.

The tilt cylinder 60 is installed between the project frame 20 and the louver frame 30, so that the solar panel 40 coupled to the louver frame 30 can be tilt-opened and closed with respect to the project frame 20.

### EXPLANATION OF QUOTATION MARK

10 Window frame
11 Threshold
20 Project frame
21 Upper cover
22 Side cover
23 Duct
24 Hinge bar
25, 32-2, 33-1 Wire hole
30 Louver frame
31 Supporting plate
31-1 Tilt hole
32 Panel holder
32-1 Tilt shaft
32-3 One end of panel holder
32-4 The other end of panel holder
32-5 Locking jaw
32-6 Bolt hole
33 Socket
33-2 Protrusion
34 Tilt strip
34-1 Hole
35 Bolt
40 Solar panel
41 Solar cell
42 Photovoltaic frame
43 Connector
50 Project cylinder
60 Tilt cylinder

### CROSS-REFERENCE TO RELATED APPLICATION

The instant patent application claims priority under 35 U.S.C. 119(a) to Korean Patent Application No. 10-2021-0078008, 10-2021-0078017, and 10-2021-0078026 filed on Jun. 16, 2021, in the Korean Intellectual Property Office, the disclosure of which is herein incorporated by reference in its entirety. The present patent application claims priority to other applications to be filed in other countries, the disclosures of which are also incorporated by reference herein in their entireties.

1. A project type window system, comprising:
a window frame;
a project frame with an upper end hinged to an upper end of the window frame configured to be opened and closed in a project type while moving away or close with respect to the window frame;
a louver frame provided inside the project frame; and
a solar panel including a solar cell and a photovoltaic frame to support the solar cell;
wherein the project frame includes an upper cover, a side cover, a lower cover, and a hinge bar coupled on the upper cover to enable the project frame to rotate in a project type that form a quadrangular frame;
wherein wire holes are formed at the upper cover, the side cover and the hinge bar; and
wherein an electric wire coupled to the solar panel is connected to an external device through the wire hole of the side cover, the upper cover, and the hinge bar.

2. The project type window system of claim 1, wherein the louver frame includes
a supporting plate elongated in a height direction of the project frame;
a panel holder for fixing and holding the solar panel inside of the supporting plate;
a socket for tiltably supporting the solar panel with respect to the louver frame from an outside of the supporting plate; and
a tilt frame for rotating the socket at the same time;
wherein a recess is formed in the tilt frame.

3. The project type window system of claim 2, wherein the supporting plate includes a tilt hole;
wherein the panel holder includes a tilt shaft on an opposite side to which the solar panel is held, and the tilt shaft is inserted into the tilt hole;
wherein the socket is coupled to the tilt shaft;
wherein the photovoltaic frame is slide-inserted through an opened one end of the panel holder, and is supported by the other end of the panel holder; and
wherein the photovoltaic frame is coupled to the panel holder in the other end of the panel holder.

4. The project type window system of claim 1, wherein the socket includes one or more protrusions;
wherein the louver frame further includes a tilt strip with a hole formed at a position corresponding to the protrusion of the socket; and
wherein the tilt strip connects the protrusion of the socket in the height direction of the project frame, so that a plurality of the solar panels can be entirely tilted.

5. The project type window system of claim 1, wherein the photovoltaic frame is divided into three or more including a first subframe corresponding to any one of both ends of the photovoltaic frame, a third subframe corresponding to the other one of both ends, and a second subframe connecting the first subframe and the third subframe.

6. The project type window system of claim 1, wherein both ends constituting a width of the photovoltaic frame have a thickness thinner than a thickness of the solar panel; and
wherein a slit and a protrusion are formed at the both ends, and a protrusion of an adjacent solar panel is inserted into a slit of the solar panel when the solar panel is closed.

7. The project type window system of claim 6, wherein a holding portion is formed at the both ends of the photovoltaic frame; and
wherein a water stop rubber is inserted into the holding portion, so that the water stop rubbers are compressed with each other when the adjacent photovoltaic frames come into contact with each other.
